(19) United States
(12) Patent Application Publication
(10) Pub. No.: US 2005/0208928 A1
(43) Pub. Date: Sep. 22, 2005

(54) Communication system with an extended coverage area

(75) Inventors: David M Avery, Woking (GB); Ian A Marsden, Redhill (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/518,738

(22) PCT Filed: Jun. 6, 2003
(86) PCT No.: PCT/IB03/02554

§ 371 Date: Dec. 16, 2004

(30) Foreign Application Priority Data
Jun. 21, 2002 (GB) 0214302.2

(51) Int. Cl. H04M 11/00

(52) U.S. Cl. 455/412.2

(57) ABSTRACT

A radio communication system (20) is described having a primary-secondary star-like topology, and wherein further secondary stations/devices (24) located outside of the radio coverage area (13) of the primary station are enabled to communicate with the primary station (12) via a first secondary station (22) located within the coverage area of the primary station (12). This is achieved by the first secondary station (22) registering the further secondary station(s) with both itself and the primary station (12), following which messages are exchanged between the primary station and the further secondary station(s) via the first secondary station according to translation of identity codes allocated at the time of registration.

### TECHNICAL FIELD

The present invention relates to a method of extending the radio coverage area of a radio communication system, and further relates to radio devices/stations suitable for practising said methods. The present invention has particular, but not exclusive, application to low cost and low data rate master/slave radio communication systems.

### BACKGROUND ART

Short range radio networks having a primary (or master) station which subsequently registers or associates secondary (or slave) stations with itself to form a master/slave radio communication system and network in which radio messages comprising data packets are exchanged between stations under the control of the primary station are generating much interest. The interoperability of such primary/secondary stations depends on each device having a predetermined and standardised radio protocol, such as those defined in the 802 family of radio standards adopted by the IEEE™. A well-known example of such a protocol is the Bluetooth™ protocol. Another protocol in development at the time of this patent application is that being developed by the ZigBee Alliance group of companies (www.zigbee.org). The main aims of the ZigBee Alliance are to define a protocol and radio stack suitable for low data rate, low power applications such that radio stations or devices incorporating the ZigBee standard are of low cost and interoperable.

It is hoped that such low cost self-configuring radio networks will open up many home consumer and industrial control markets, for example in heating and lighting applications. The ZigBee alliance group of companies are aiming to produce radio station devices with a target cost of less than $2 at the time of writing, with such devices having relatively simple microcontrollers acting as a microprocessor and a limited amount of on-board memory available.

However, a ZigBee radio communication system comprising a primary station and associated slave or secondary stations has, at the time of making this application, a limited radio coverage area related directly to the conventional radio broadcast range of the primary station which is estimated to be in the region of a few tens of metres for a ZigBee system communicating in one of the 16 channels defined in the 2.4 GHz ISM band.

Hence in the area of control and instrumentation, radio communication systems and networks in a large building have to be planned and installed carefully to ensure good radio coverage. A problem exists if a secondary station is transported out of the radio coverage area of its primary station, or is located in a poor radio reception area and therefore cannot receive or transmit messages to and from its primary station.

### DISCLOSURE OF INVENTION

It is therefore an object of the present invention to extend the radio coverage area of a communication system to mitigate the above problem.

### SUMMARY OF INVENTION

According to a first aspect of the present invention there is provided a method for extending the radio coverage area of a communication system operating according to a predetermined radio protocol, the system comprising a primary station having a radio coverage area, a first secondary station within the coverage area and a further secondary station which is located outside of the radio coverage area of the primary station, the method comprising a message exchange process in which:
the first secondary station receives from the primary station messages intended for the further secondary station; and
transmits said messages to the further secondary station; and
the first secondary station receives from the further secondary station messages intended for the primary station; and
transmits said messages to the primary station.

According to a second aspect of the present invention there is provided a communication system operating according to a predetermined radio protocol and comprising a primary station having a radio coverage area, a first secondary station within the coverage area and a further secondary station which is located outside of the radio coverage area of the primary station, the first secondary station having means for receiving from the primary station messages intended for the further secondary station, for transmitting said messages to the further secondary station, for receiving from the further secondary station messages intended for the primary station and for transmitting said messages to the primary station.

According to a third aspect of the present invention there is provided a first secondary station for use in a communication system operating according to a predetermined radio protocol and having a primary station having a radio coverage area, and a further secondary station which is located outside of the radio coverage area of the primary station, the first secondary station being located within the radio coverage area of the primary station and comprising means for receiving from the primary station messages intended for the further secondary station, for transmitting said messages to the further secondary station, for receiving from the further secondary station messages intended for the primary station and for transmitting said messages to the primary station.

Preferably there is also provided a registration process in which:
the further secondary station transmits to the first secondary station a message comprising registration information, and
the first secondary station transmits said registration information to the primary station to register the further secondary station with the primary station.

Owing to the invention communication involving exchange of messages between a primary station and a further secondary station located outside of the coverage area of the primary station is established via a first secondary station within the radio coverage area of a primary station. The first secondary station acts to relay messages either from or too the respective stations. Preferably the first secondary station registers or associates the further secondary station with itself, and further passes on the registration information to the primary station which also registers the further secondary station. The registration involves in one embodiment each station allocating a short identity code to the further secondary station with the first secondary station associating or linking the respective identity codes. Messages are then routed by the first secondary station according to the linked identity codes contained within a message.

In an example embodiment the primary station is located in a building and forms part of a lighting system having other secondary stations including the first secondary station located in lamps or luminaires and associated lamp switches. The system exchanges messages comprising radio data packets according to a communication protocol as defined by the ZigBee Alliance. The primary station synchronises communication (exchange of messages) with the first secondary station (and any others within its radio coverage area and previously registered with it) by supplying a periodic reference or “beacon” signal. The first secondary station reserves a portion of the time interval between beacons for itself and during this interval receives or transmits any messages intended for the further secondary station. The first secondary station also operates to serve its default application, in this example as a lighting controller in a lamp ballast.

Hence a primary station provided in the infrastructure of a building has its radio coverage area effectively increased by the provision within the infrastructure of at least one first secondary station as part of the communication network. This first station operates to perform its default function and application once installed, but is also capable of providing a message exchange service to further secondary stations which may be located (or become located at a future date) outside of the radio coverage area of the primary station. Alternatively the environment around a secondary station may be altered (in an open-plan office environment for example) at a future date thereby creating a radio null spot or reflection area which removes the ability of the secondary station unable to establish communication with the primary station, rendering the secondary station a further secondary station. The first secondary station can be employed in such instances to enable message exchanges between the further secondary station and the primary station via itself.

Thus a flexible infrastructure is provided enabling a greater coverage area and a more robust network to be obtained. Moreover the additional installation of secondary stations at a future date is eased with the chance of radio communication between the secondary stations and a primary station being increased without extensive radio coverage planning.

### BRIEF DESCRIPTION OF DRAWINGS

The present invention will now be described, by way of example only, and with reference to the accompanying drawings wherein:

FIG. 1 is a block schematic diagram of a radio network having a primary and several secondary stations.

FIG. 2 is a schematic diagram of a radio network comprising a first secondary station according to the present invention.

FIG. 3 is an example of tables stored by the primary and first secondary station for use with a method of the present invention.

FIG. 4 is a flowchart representing a registration method embodying an aspect of the present invention.

FIG. 5 illustrates flowcharts representing exemplary steps for a method of exchanging messages according to the present invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

### DETAILED DESCRIPTION

In the following example a wireless lighting network in a building is used to illustrate the principles of this invention, the network and devices therein forming a communication system operating according to a radio protocol such as that defined as the ZigBee standard by the ZigBee Alliance.

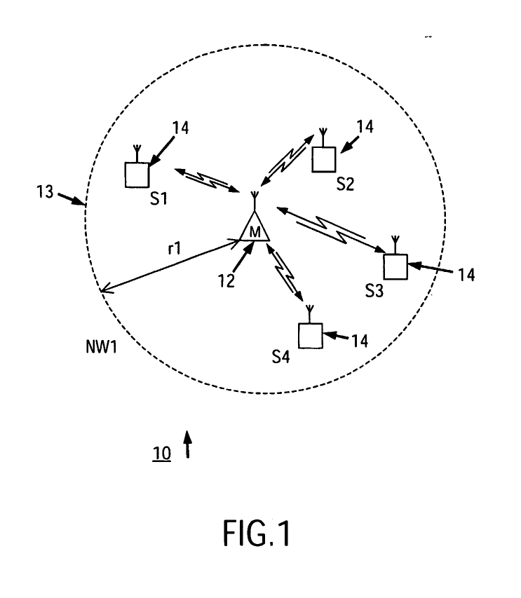

A known radio network 10 is schematically illustrated in FIG. 1 and comprises a master or primary station (M) 12 which includes a transceiver controlled by a microcontroller or microprocessor. The primary station 12 is powered from the mains or other suitable supply such as a generator and has a broadcast range indicated as r1 in the diagram giving a radio coverage area 13 indicated by the dashed circle in the Figure. The primary station stores in a memory coupled to the microcontroller information concerning a plurality of secondary stations 14, each secondary station having a unique 64-bit identifier (S1, S2, S3 in the Figure), a transceiver and a microcontroller to enable communication with the primary station 12. The secondary stations (often called slave devices) have previously registered with the network primary station 12 by an enumeration process, whereby the primary station 12 receives the unique identifier of a secondary device and provides that secondary device with a shorter identity such as an 8-bit radio identity code (RIC1). (The enumeration process is more fully described in Applicant's co-pending International patent application WO0128156 published on the 19^{th} Apr. 2002, and to which the reader is now directed and the disclosure of which is incorporated herein by reference).

In an example embodiment of a lighting application utilising the network of FIG. 1, the secondary stations 14 are provided in ceiling lamps and light switches, with the light switches being battery powered for example. In such a lighting system, following enumeration, the switches and lamps undergo a configuration step in which they are logically linked or paired according to user preferences. Such a pairing process enables a user to link one device (a light switch) with another device (a lamp) and is more fully described in Applicant's co-pending International patent application WO0128157 published on the 19^{th} Apr. 2002, and to which the interested reader is now directed for the sake of completeness. Thus pairing enables one slave or secondary station to appear to control another station registered on the network, even though the network is of a Master-Slave topology in which the slaves (secondary stations) only communicate directly with the master station (primary station) and usually are simple radio devices having limited memory and processing resources and therefore limited knowledge of the network to which they belong.

Whether a station is a slave or a master, and what application that station is intended for depends on any application specific code supplied with the microcontroller for instance, of each slave, along with a radio protocol stack, in this example that as specified by the ZigBee Alliance.

One mode in which such a network as that shown in FIG. 1 operates in accordance with the protocol is that of “Beaconing” on a single frequency channel, where a primary station 12 sends out a periodic reference or beacon signal on a single frequency channel (ZigBee defines 16 channels in the 2.4 GHz ISM band), which secondary stations receive and react to. The reference signal contains indications of which secondary stations for which data is intended or pending, with the secondary stations responding in accordance with a multiple access protocol. For example a carrier sense multiple access (CSMA) process may be utilised in which a transceiver checks that the frequency channel is free before transmitting. However, this does not avoid clashes resulting from a second transceiver checking the frequency channel during the brief interval that a first transceiver is preparing to transmit following checking that the frequency channel is free. A contention resolution scheme, such as a random exponential backoff scheme may be employed to try and avoid the first and second transceivers from retrying at the same instant.

When a secondary station transceiver detects an indication in the beacon signal that data is pending, it transmits a data request message which includes its radio identity code (RIC) (allocated by the primary station during initial enumeration) to the primary station, and then activates its receiver. The primary (master) station receives the data request, checks if it has a data message for the particular radio identity code (RIC) and, if it has, transmits a data packet to that secondary station, which acknowledges the message to complete the transaction. Additionally, the primary station may be put into an enumeration or registration mode, for example by means of a user input button on the primary station or by a request from a secondary station, with the primary station signalling that it is accepting new devices in the beacon signals, and new devices (for example a lighting remote control device) can join the network and subsequently be paired with relevant lamps according to user preference.

In this fashion a simple radio network is set up and configured for operation, with the master servicing the registered secondary stations within the radio coverage area 13 as described.

A problem exists if a secondary station is positioned in an area where poor radio reception of the transmissions from the primary station is experienced, for example where reception is blocked by obstacles or where reception suffers from interference from another radio source. The secondary station is then said to be outside of the radio coverage area of the primary station and cannot join or participate in the network.

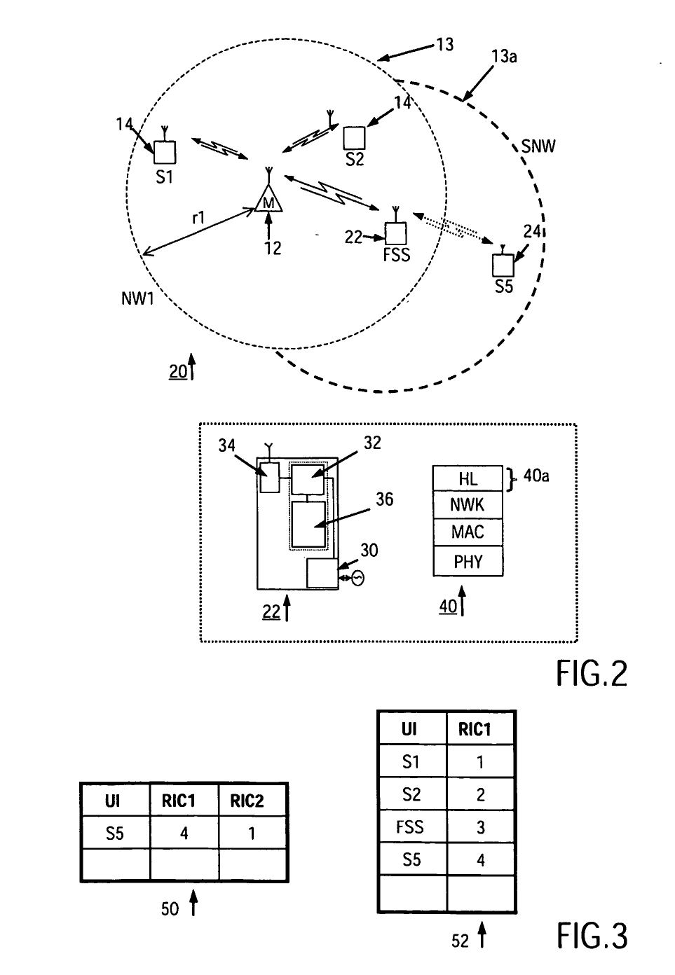

FIG. 2 illustrates a system 20 made in accordance with the present invention wherein a further secondary station (S5) 24 is located a distance greater than r1 from the network primary station 12 (M) and is therefore outside of the radio coverage area of the primary station and hence is unable to communicate with the primary station. The secondary station corresponding to S3 (in FIG. 1) has been replaced however in this system by a first secondary station 22 (FSS).

The first secondary station 22 is preferably powered by a constant mains supply 30, such as would be available if the first secondary station 22 was incorporated in the ballast of a ceiling lamp. The first secondary station 22 comprises (see inset FIG. 2) a microprocessor or microcontroller 32 coupled to a transceiver 34 and a memory 36 and is registered with the primary station 12 as a lamp controlling device and may be paired with an appropriate light switch device as described previously. The application code occupying the higher layers 40a of the ZigBee radio protocol stack 40 provided with the microcontroller provides this functionality (in this case as a controller for a lamp ballast) but additionally provides the first secondary station with a registration and message exchange process which enable the first secondary station 22 to register a further secondary station 24 with the primary station 12, and following this to relay messages between the primary 12 and further secondary station 24.

In this embodiment the first secondary station reserves a portion of the time period between the primary station beacons (beacon frame) for itself, which has the effect that other registered secondary stations (S1, S2) do not attempt to transmit to the primary station 12 during this reserved period. During this period the first secondary station 22 transmits its own reference beacon signal, and registers and exchanges messages for any further secondary stations that respond to the first secondary station's beacon. The first secondary station 22 in effect forms a surrogate network (SNW) with the further secondary station 24 and provides an effective extension in radio coverage area 13 as indicated schematically in FIG. 2 by the dashed circle 13a.

Example Registration process

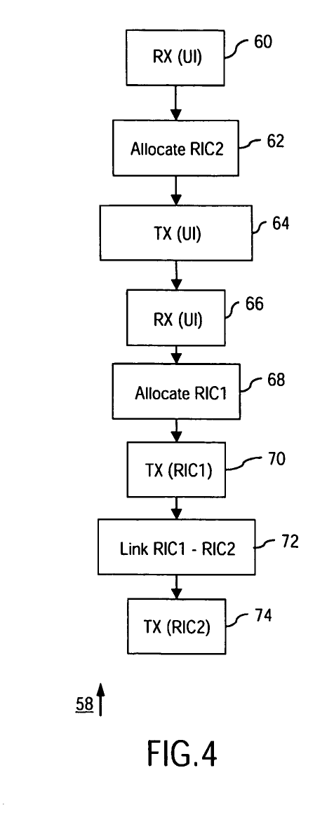

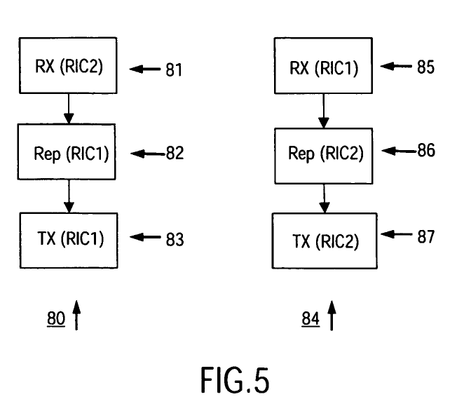

An example of the data tables stored in memory 36 of the first secondary station 22 and the primary station 12 are shown in FIG. 3. These tables are constructed during a registration process as illustrated in FIG. 4 and which will now be described with reference to FIG. 3 and FIG. 4. In step 60 of the registration process the first secondary station 22 stores a unique identifier [RX (UI)] received from the further secondary station 24 and in step 62 allocates a short 8 bit radio identity code [RIC2] to the further secondary station 24 and stores this code and any other device information obtained from, and concerning the capability of, the further secondary station in the table 50 in memory 36. In the illustrated example the first secondary station 22 has allocated an RIC2 of 1 to the further secondary station (UI of ‘S5’) in Table 50. The first secondary station 22 subsequently requests registration with the primary station 12 and transmits in step 64 [TX(UI] the unique identifier and any other information collected from the further secondary station in step 60 to the primary station 12. The primary station 12 receives this information in step 66 [RX(UI)] and updates its network table 52 (FIG. 3) with an entry for the received device identifier UI and further allocates (step 68) a short radio code to that identifier. In this example the table 52 of FIG. 3 has a UI entry ‘S5’ and an allocated short radio code RIC1 of 4. In step 70 the primary station transmits the allocated short radio code RIC1 to the first secondary station 22 which as indicated in step 72 of the process links the received RIC1 with the RIC2 code which it allocated to the further secondary station 24. This is indicated in the example table 50 of FIG. 3 where the RIC1 column has been updated with the value received from and allocated by the primary station 12. Finally in step 74 the first secondary station 22 transmits to the further secondary station the code it allocated [TX(RIC2)] to the further secondary station thereby enumerating the further secondary station 24 on the surrogate network with the radio code RIC2.

Example Message Exchange process

By following the process 58 of FIG. 4 the first secondary station 22 has stored in table 50 in memory 36 the radio code (RIC1) which the primary station has allocated to the further secondary station and also the radio code (RIC2) which it has allocated to the further secondary station 24. The further secondary station subsequently indicates a message as originating from itself by sending with the message its allocated RIC2. The further secondary station, on receiving such a message, looks up the associated RIC1 and transmits the message with the associated RIC1 value over the air to the primary station 12. This uplink portion of a message exchange process is illustrated by way of example in the flowchart 80 of FIG. 5.

Similarly, a message generated by the primary station 12 which is intended for the further secondary station 24 is transmitted with identity code RIC1 by the primary station. This is received by the first secondary station 22 which replaces the RIC1 identifier with the linked RIC2 identifier stored in its table 50. The message is then transmitted by the first secondary station 22 onwards to the further secondary station 24. This downlink portion of a message exchange process is illustrated by way of example in the flowchart 84 of FIG. 5.

Hence messages are exchanged in the system according to the first secondary station replacing the identity code received with a message with the associated identity code stored in the table 50 and transmitting the message onwards.

In the above embodiment the exchange of messages is synchronised according to a beacon signal transmitted by the primary station 12, and another transmitted by the first secondary station 22. Additionally, the placing of a first secondary radio station is by way of example in a lamp ballast. This provides permanent power to the first secondary radio to enable reliable transmission of signals, and provides, since lamp ballasts are usually ceiling mounted, a large coverage area for transmission. Hence the installation of a wireless lighting infrastructure comprising at least one primary station and at least one first secondary station enables further wireless devices to be easily installed without extensive radio coverage planning or broadcast range estimations.

For example, the present invention advantageously enables heating installations comprising thermistors and other sensors to be applied within or about the building without detailed and expensive radio installation planning to be carried out. If a sensor containing a radio device is unable to communicate with a primary station, then it may be able to communicate with a first secondary station and from there to the primary station, enabling a quicker and easier installation.

In the above a packet radio system employing a star or master/slave topology is described, the system operating according to a predefined protocol and wherein communication between stations is enabled via a first secondary station. The coverage area of the primary station is effectively increased leading to a more robust communication system. Whilst the above embodiments describe a system utilising a ZigBee radio protocol, those skilled in the art will recognise that other packet radio data protocols may be used.

From reading the present disclosure, other modifications will be apparent to persons skilled in the art. Such modifications may involve other features which are already known in the design, manufacture and use of primary/secondary stations, communication systems, infrastructure and component parts thereof and which may be used instead of or in addition to features already described herein without departing from the spirit and scope of the present invention.

In the present specification and claims the word “a” or “an” preceding an element does not exclude the presence of a plurality of such elements.

1. A method for extending the radio coverage area (13) of a communication system (20) operating according to a predetermined radio protocol (40), the system comprising a primary station (12) having a radio coverage area, a first secondary station (22) within the coverage area and a further secondary station (24) which is located outside of the radio coverage area of the primary station, the method comprising a message exchange process (80,84) in which:
the first secondary station receives from the primary station messages intended for the further secondary station; and
transmits said messages to the further secondary station; and
the first secondary station receives from the further secondary station messages intended for the primary station; and
transmits said messages to the primary station.

2. A method according to claim 1, wherein the message exchange process follows a registration process (58) in which:
the further secondary station (24) transmits to the first secondary station (22) a message comprising registration information, and
the first secondary station (22) transmits said registration information to the primary station (12) to register the further secondary station (24) with the primary station.

3. A method according to claim 2, wherein the registration information comprises a unique identifier identifying the further secondary station (24), and wherein:
the primary station (12) registers the further secondary station by allocating a first identifier (68) associated with the unique identifier of that station and transmits (70) said first identifier to the first secondary station (22),
and wherein the first secondary station (22) allocates a second identifier (62) associated with the first identifier and with the unique identifier and transmits the second identifier to the further secondary station (24), and wherein messages are subsequently exchanged (80,84) according to the associated identifiers.

4. A method according to claim 3, wherein communication between the primary station (12) and the first secondary station (22) is synchronised according to a first periodic beacon signal transmitted by said primary station.

5. A method according to claim 4, wherein the first secondary station (22) reserves a portion of the time period between the periodic beacon signals, and wherein the first secondary station transmits and receives messages to and from the further secondary station (24) during this reserved time period.

6. A method according to claim 1, wherein the predetermined radio protocol (40) is that defined as the ZigBee radio standard.

7. A communication system operating according to a predetermined radio protocol and comprising a primary station (12) having a radio coverage area (13), a first secondary station (22) within the coverage area and a further secondary station (24) which is located outside of the radio coverage area of the primary station, the first secondary station having means (32,34,50) for receiving from the primary station messages intended for the further secondary station, for transmitting said messages to the further secondary station, for receiving from the further secondary station messages intended for the primary station and for transmitting said messages to the primary station.

8. A communication system according to claim 7, wherein the first secondary station (22) further comprises means for receiving a message comprising registration information from the further secondary station (24) and means for transmitting said registration information to the primary station (12) to register the further secondary station with the primary station.

9. A communication system according to claim 7, wherein the exchange of messages (84) between the primary station (12) and the first secondary station (22) is synchronised according to a periodic beacon signal transmitted by said primary station.

10. A communication system according to claim 9, wherein the first secondary station (22) reserves a portion of the time period between the periodic beacon signals, and wherein the first secondary station transmits to, and receives messages from the further secondary station (24) during this reserved time period.

11. A communication system according to claim 7, wherein the predetermined radio protocol (40) corresponds to the ZigBee radio standard.

12. A first secondary station (22) for use in a communication system (20) operating according to a predetermined radio protocol (40) and having a primary station (12) having a radio coverage area, and a further secondary station (24) which is located outside of the radio coverage area of the primary station, the first secondary station (22) being located within the radio coverage area of the primary station and comprising means for receiving from the primary station messages intended for the further secondary station, for transmitting said messages to the further secondary station, for receiving from the further secondary station messages intended for the primary station and for transmitting said messages to the primary station.

13. A first secondary station as claimed in claim 12 further comprising means for receiving a message comprising registration information from the further secondary station and means for transmitting said registration information to the primary station to register the further secondary station with the primary station.

14. A first secondary station as claimed in claim 12 wherein the predetermined radio protocol corresponds to the ZigBee radio standard.

15. (cancel)

16. (cancel)

17. (cancel)
